(19) United States
(12) Patent Application Publication
(10) Pub. No.: US 2017/0106421 A1
(43) Pub. Date: Apr. 20, 2017

(54) MANUFACTURING OF LITZ WIRE

(71) Applicant: Koninklijke Philips N.V., Eindhoven (NL)

(72) Inventor: BERNHARD GLEICH, EINDHOVEN (NL)

(73) Assignee: Koninklijke Philips N.V., Eindhoven (NL)

(21) Appl. No.: 15/314,960

(22) PCT Filed: May 18, 2015
(86) PCT No.: PCT/EP2015/060824

§ 371 Date: Nov. 30, 2016

(30) Foreign Application Priority Data
Jun. 6, 2014 (EP) 14171592.0

(51) Int. Cl. B21C 37/04; H01B 7/30; H01B 7/02; H01B 13/00; H01B 13/06

(52) U.S. Cl. CPC B21C 37/047; H01B 13/0006; H01B 13/0036; H01B 13/06; H01B 7/02; H01B 7/30; H01B 1/023

(57) ABSTRACT

The present invention relates to manufacturing of litz wire. In order to provide thinner litz wires, a system (100) for manufacturing litz wire is provided, the system comprising a provision unit (102) and a conversion unit (104). The provision unit is configured to provide a strand (106) with a plurality (108) of thin conductive wires (110) embedded in a matrix (112), which matrix is having first characteristics comprising metallic connection of the conductive wires and the matrix, and comprising electrical conductivity for electrically connecting of the conductive wires and the matrix. The conversion unit is configured to convert at least a part of the matrix into material (114) having second characteristics comprising electrical insulation for providing at least a part of the plurality of thin conductive wires with an electrical insulation.

### FIELD OF THE INVENTION

The present invention relates to litz wire, and relates in particular to a system for manufacturing litz wire, to a method for manufacturing litz wire and to a litz wire.

### BACKGROUND OF THE INVENTION

Litz wire is used, for example, for applications where the AC-resistance of the wire should be reduced, such as in high frequency applications, for which frequency litz wire is used. The maximum operation frequency scales with the inverse of the square of the diameter of the conductors. However, the conductor diameter is limited by a minimum economically acceptable conductor diameter, for example about 30 μm (micrometer). It has been shown further, that the cost of the conductor (per mass) increases stronger than the square of the inverse diameter, as this is the scaling of the operation time of the drawing machine. A technical limitation of the drawing process is approximately below 10 μm, or even below 5 μm, but the limit for the stranding process is not much below 20 μm due to frequent bakes of the individual conductors. However, it has been shown that to reach attractive sales, the litz operation frequency is extended to several 100 MHz. This would result in individual conductor diameters of a lower value as technically possible.

### SUMMARY OF THE INVENTION

There may thus be a need to provide more economic litz wire, and also thinner litz wire, and in particular a system for manufacturing such litz wire and a method for manufacturing such litz wire.

The object of the present invention is solved by the subject-matter of the independent claims, wherein further embodiments are incorporated in the dependent claims.

It should be noted that the following described aspects of the invention apply also for the system for manufacturing the litz wire, for the method for manufacturing litz wire, and for the litz wire.

According to a first aspect of the present invention, a system for manufacturing litz wire is provided. The system comprises of a provision unit and a conversion unit. The provision unit is configured to provide a strand with a plurality of thin conducted wires embedded in a matrix. The matrix is having first characteristics comprising metallic connection of the conducted wires and the matrix. The matrix further comprises electrical conductivity for electrically connecting of the conductive wires and the matrix. The conversion unit is configured to convert and/or replace at least a part of the matrix into material having second characteristics comprising electrical insulation providing at least a part of the plurality of thin conductive wires with an electrical insulation. This conversion/replacement is particularly done while preserving and not necessarily mechanically act or extract on the conductive wires.

This provides the advantage that the thin conductive wires are supported in the matrix and can thus be handled in a facilitated manner, in particular in view of further diameter reduction to provide thinner wires. For example, multiple wires are embedded in the metal matrix and may then be applied to a drawing procedure. As a subsequent step, the matrix is exchanged into, or converted to an insulator. Further, as an example, twisting and stranding may be done before, in between or after the conversion step. More particularly, the conductive wires are not necessarily extracted from the matrix and are therefore preserved from mechanical manipulation, which gives the possibility to provide thinner wires. Only the matrix is manipulated, but preferably not mechanically and preferably chemically (e.g. oxidization, etching, etc.) in such a way that the conductive wires are preserved (before or after an optional additional drawing step). Again this preservation of the bundles of conductive wires in an insulation shell can lead to thinner conductive wires, enables a further manipulation and/or mechanical deformation of the assembly (including twisting of the assembly to provide e.g. a Litz wire or Litz cable), leading to a safer, at lower cost manufacturing. So this invention is particularly interesting to implement for conductive wires used for (very) high-frequency applications for which the skin effect has an important impact as previously explained.

The provision unit may be connected to a strand production line, in which the matrix and the plurality of thin wires are combined such that the thin wires are embedded in the matrix.

The technical term “litz wire” refers to the German expression “Litzendraht”, also known as “Litze”, which generally relates to braided or stranded wire or woven wire. In such a wire a number of small diameter wires, i.e. thin wires are added to form a cable-like structure. The small size wires are braided or interwoven etc. to form the electrical connection.

A strand refers to a strain, section, thread or line, i.e. a linear longitudinal cable-like element. In one example, a strand relates to a drawn multifilament wire.

In the context of the present invention, the term litz wire refers only to stranded wire where the conductors are insulated to the other conductors.

As an example, the conductive wires are made from highly conductive material (see also below).

According to an example, the conductive wires are metal wires and preferably the wires belong to at least one of the group of copper wires, copper alloy wires, aluminium wires, and aluminium alloy wires.

According to a second aspect of the present invention, also a method for manufacturing litz wire is provided. The method comprises the following steps:

a) providing a strand with a plurality of thin wires made from conductive material embedded in a matrix, which matrix is having first characteristics comprising metallic connection of the conductive wires and the matrix, and comprising electrical conductivity for electrically connecting of the conductive wires and the matrix; and
b) converting and/or replacing at least a part of the matrix into material having second characteristics comprising electrical insulation for providing at least a part of the plurality of thin conductive wires with an electrical insulation.

In an example, in step a), the strand is provided as a metal cylinder comprising bores filled with copper.

In an example, the term “thin” relates to a diameter of approximately less than a few μm (micrometer). Hence, a strand may be provided with a diameter of approximately less than 80 μm.

In another example, the term “thin” relates to a diameter of approximately less than 80 μm (micrometer). Hence, a strand may be provided with a diameter of up to half a millimetre.

The term “a plurality” of thin copper wires or wires made from conductive material relates to at least three conductors in the matrix.

The matrix is provided as a structural support for the plurality of thin wires. In an example, all conductive wires are provided with an electrical insulation. The conversion is also referred to as transformation.

The term “conductive material” relates to, for example, metals that would work as the conductors in the litz wire. An example is copper, aluminium or alloys thereof. However, also other materials can be provided. Copper is a suitable material because it is relatively cheap, has a good corrosion resistance and has excellent conductivity. Aluminium is also suitable. Further, silver, gold and platinum metals are also provided, despite of being more expensive as raw material. Magnetic metals are less useful and they have an additional loss mechanism. Zinc and tin are also provided as alternatives. Pure metals may be provided, but also alloys, in particular copper alloys are provided.

It is noted that the losses increase with the square root of the resistivity, as long as the operating frequency is high enough that eddy currents dominate the losses. In an example, the litz wire as the manufactured product is used in this regime.

According to an example, before step b), it is provided a step of drawing the strand for using a cross section of the embedded conductive wires.

In an example, also a cross section of the matrix is reduced during rolling and/or drawing. For example, the metal cylinder is provided with an outer diameter of approximately 10 to 100 cm (centimetre). After the drawing procedure, the metal cylinder is provided with an outer diameter of approximately 10 to 100 μm. In an example, the cylinders are first rolled and then drawn.

In an example, in step b), it is provided the step of exchanging the matrix for the conversion into the electrical insulation.

In an example, the conversion is provided as a direct or one-step conversion. In another example, the conversion is provided as a two (or more) step conversion, e.g. as a multiple step reaction. For example, an intermediate hydride is formed that is then converted to the oxide using oxygen or water.

According to an example, the matrix comprises a matrix material and at least a first material. In step b), the following substances are provided:

b1) converting the first material to form a plurality of cavities in the matrix; and
b2) using the formed cavities for activation of a second conversion sub-step, in which the matrix material is converted and/or replaced into insulation.

In an example, the first material is dissolved, thus forming a plurality of cavities.

According to an example, before or after the conversion sub-step, it is provided the sub-step of the filling the cavities with a second material.

According to an example, after filling the cavities with a second material, it is provided the sub-step of dissolving the matrix material in a second dissolving sub-step.

According to an example, in step b), it is provided the sub-step of dissolving the matrix completely and providing a polymerization for separating the wires, wherein for the polymerization, monomers polymerize by a catalytic surface of the conductive wire.

According to an example, in the strand, embedded in the matrix, the conductive wires are enclosed by an embedding coating that is arranged around each conductive wire. In step b) it is provided sub-steps of dissolving the embedding coating, providing an insulation of the conductive wires, and dissolving the matrix.

The embedding coating comprises sub-steps of dissolving the embedding coating, providing an insulation of the conductive wires, and dissolving the matrix.

The embedding coating is providing a lining for voids in the matrix, inside which voids the copper wires are arranged.

According to an example, it is provided a step of twisting or weaving of the plurality of thin conductive wires, for example before, during or after the step b).

The terms twisting and weaving also refer to stranding of the small sized wires to form a cable-like element.

According to a third aspect of the present invention, a litz wire is provided, comprising a plurality of thin conductive wires that are electrically insulated from each other. The plurality of thin conductive wires are embedded in a matrix, at least a part of the matrix having been converted and/or replaced from a conductive material to or by an electrically insulated material.

In an example, as a result from the conversion of one metal into an insulator, a litz wire is provided where the conductive material is at least partially covered by a metal salt insulator.

In another example, the litz wire is a wire, which has at some frequency a lower resistance than the resistance of the conducting material (e.g. copper) as homogeneous conductor in some winding pattern of the wire.

In an example, as insulating metal salt, a ionic compound of a metal (e.g. Al, Ti, Nb) with a conductivity at least 6 orders of magnitude lower than copper.

In an example, a minimum amount of ionic insulator, e.g. at least 10% per weight of the conductor, and/or a maximum individual conductor diameter, e.g. 80 μm, is provided.

In an example, for the catalytic conversion, a litz wire is provided with a catalytically polymer insulator that is formed at the surface of the wire.

In further embodiments of the Litz wire:
it further comprises a non-uniform concentration of some impurities, the material of these impurities being different from the conductive material of the conductive wires and the insulator material in the matrix, whose concentration may decrease from the outer surface to the inner portion of the Litz wire,
the matrix is mostly made of metal oxide,
it further comprises a nose or filling channel on the insulator material of the matrix or on the conductive wires, and/or
it further comprises nose or filling channel on conductive wires and no or little polymer on top of them.

In an example, a method is provided, where all structural metal is removed and a polymer is left over. In an example, the insulating polymer is not just a cover of the conductor with more or less equal thickness. Rather, the cover material has some structure, like triangles in one example or voids in another example. In an example, a litz wire is provided with a polymer insulator with at least 10% of radial directions, the thickness of the insulator deviating from the average thickness by at least 30%.

According to an aspect, the electrically conductive wires are first embedded in a matrix material that itself is electrically conductive, thus electrically connecting the thin wires. However, as a second step, the matrix material is transferred into a state, in which instead of the electric connection, an electric insulation is provided.

These and other aspects of the present invention will become apparent from and be elucidated with reference to the embodiments described hereinafter.

### BRIEF DESCRIPTION OF THE DRAWINGS

Exemplary embodiments of the invention will be described in the following with reference to the following drawings:

FIG. 1 schematically shows an example of a system for manufacturing litz wire;

FIG. 2 shows basic steps of an example of a method for manufacturing litz wire;

FIG. 3A shows a further example of a method for manufacturing litz wire;

FIG. 3B schematically shows an example of a process for manufacturing litz wire;

FIG. 4A shows a further example of a method for manufacturing litz wire;

FIG. 4B shows an example of a procedure for manufacturing litz wire;

FIG. 4C shows a further example of a method for manufacturing litz wire;

FIG. 5 shows a further example of a procedure for manufacturing litz wire;

FIG. 6 shows a further example of a procedure for manufacturing litz wire;

FIG. 7 shows a further example of a procedure for generating litz wire;

FIG. 8A shows a step of a further example of a procedure for manufacturing litz wire;

FIG. 8B shows a further step of an example of the procedure, of which a step is shown in FIG. 8A;

FIG. 9 shows an example of a litz wire in a cross section;

FIG. 10 shows an example of an etching chamber for manufacturing litz wire in a schematic setup; and

FIG. 11 shows an example of an impregnation chamber for manufacturing litz wire in a schematic setup.

### DETAILED DESCRIPTION OF EMBODIMENTS

FIG. 1 shows a system 100 for manufacturing litz wire, comprising a provision unit 102 and a conversion unit 104. The provision unit 102 is configured to provide a strand 106 with a plurality 108 of thin conductive wires 110, embedded in a matrix 112. The matrix 112 is having first characteristics comprising metallic connection of the conductive wires 110 and the matrix 112, and comprising electrical conductivity for electrically connecting of the conductive wires 110 and the matrix 112. The conversion unit 105 is configured to convert and/or replace at least a part of the matrix 112 into materials 114 having second characteristics comprising electrical insulation for providing at least a part of a plurality of thin conductive wires with an electrical insulation.

In further examples, the conversion unit 104 is configured to specific conversion steps, as will be described in the following in relation with the respective method steps and examples of methods for manufacturing litz wire. Of course, the following examples, described in relation with method steps, are also provided as respective system features of the system 100 for manufacturing litz wire.

The conductive wires 110 are provided, for example, as metal wires, preferably comprising at least one of the group of copper wires, copper alloy wires, aluminium wires, and aluminium alloy wires.

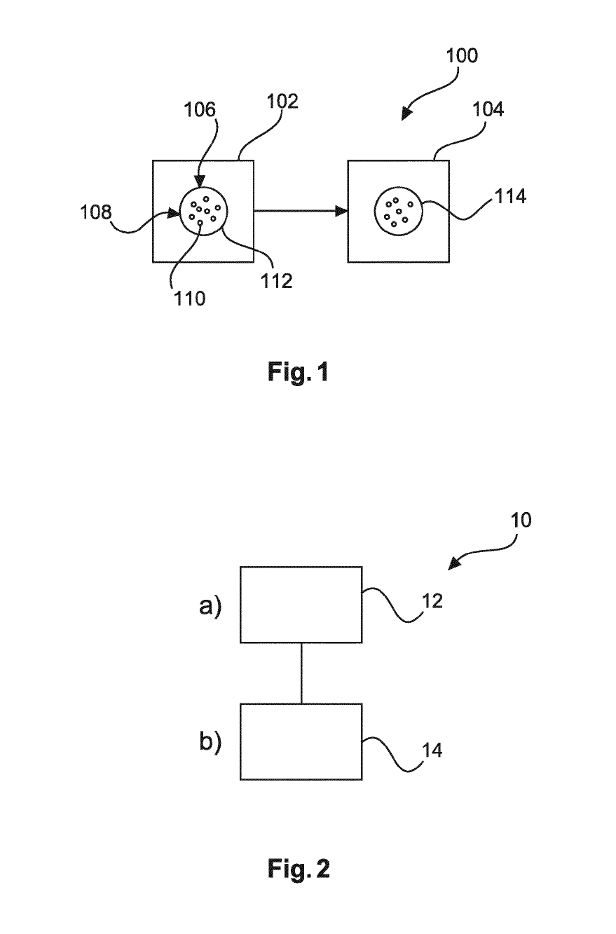

FIG. 2 shows a method 10 for manufacturing litz wire. The method 10 comprises the following steps:

a) In a first provision step 12, a strand with a plurality of thin wires made of conductive material, embedded in a matrix is provided. The method is having first characteristics comprising metallic connection of the conductive wires and the matrix, and comprises electrical conductivity for electrically connecting of the conductive wires and the matrix.
b) In a conversion step 14, at least a further matrix is converted into material having second characteristics comprising electrical insulation for providing at least a part of the plurality of thin conductive wires with an electrical insulation.

In an example, all thin conductive wires are provided with an electrical insulation.

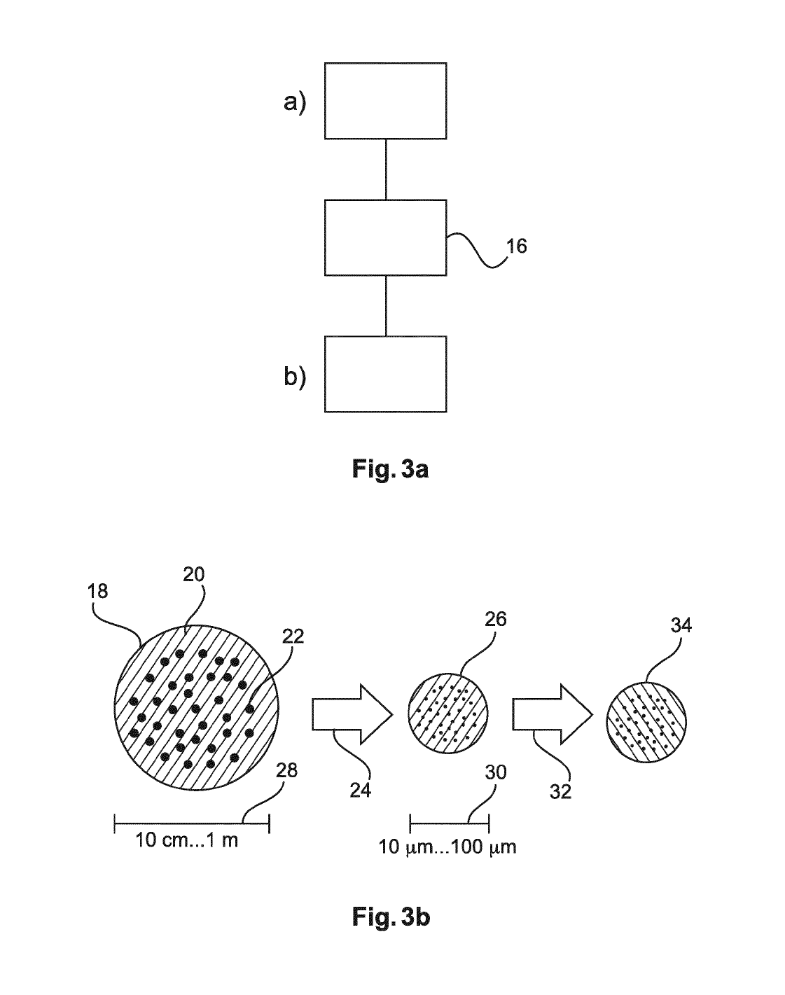

FIG. 3A shows an example, according to which before step b) it is provided the step 16 of drawing the strand for reducing the cross section of the embedded conductive wires.

According to an example, further shown in step b), it is provided the sub-step of chemically processing the matrix for the conversion into the electrical insulation. In one example, in step b), the embedding matrix is transformed into an electrically insulating matrix.

According to further example, not further shown, in the chemically processing step, a gas is provided that reacts with the matrix to form and insulating material.

In an example, direct conversion is provided. In one example, the process is provided to direct reacting of the metal matrix with gas to form an insulating material, as mentioned above. The reaction conditions are provided mild enough, such that, for example, the copper is not significantly affected. For example, a reaction with oxygen and/or water may be suitable to form insulating oxides or hydroxides, while preserving a copper, as an example. In an example, aluminium (Al), titanium (Ti), vanadium (V), tantalum (Ta) or chrome (Cr) are provided as pure materials or as alloys. In another example, nickel (Ni) is provided as a dissolvable material and aluminium as a convertible material. In one example, the matrix is completely dissolved, e.g. by liquid or gas phase reactions, and copper wires, for example, that are often referred to as copper conductors, are provided with insulation means.

In an example, where all matrix material is to be dissolved, a thin layer of catalytic material is preserved that chemically activates the formation of the insulating material. When providing the insulator for this arrangement, not the entire matrix is dissolved.

In an example, it is desired to form stable oxides to preserve flexibility. However, stable oxides tend to form slowly as diffusion through the oxides is slow, for example in aluminium. In another example, less stable oxides are provided that, however, may contain cracks and may thus need a subsequent impregnation with a polymer.

Further, hydroxide content may have the effect that a high dielectric constant is provided, which in some cases may not be desirable in terms of electric quality of the final litz wire.

FIG. 3B shows a schematic procedure for the manufacturing of litz wire. In FIG. 3B, a cylinder 18 is indicated, in which different materials are inserted. The cylinder comprises a metal matrix 20 and bores 22 filled with copper. Next, a drawing step 24 is provided in order to form a cylinder 26 with reduced diameter, which is the case for both the outer diameter of the metal cylinder as also for the respective bores 22. For example, a value 28 of 10 cm (centimetre) to 1 m (metre) is indicated below the left circle of FIG. 3B, and a further value 30 of 10 μm to 100 μm is indicated below the middle circle. As an example, a chemical processing step 32 is indicated, leading to a cylinder structure 34 comprising an insulator matrix, in which copper wires are embedded. The chemical process may be provided in different ways, as described below.

Hence, FIG. 3B shows the provision of a metal cylinder, comprising the bores filled with copper that are then transformed by a drawing process to have a smaller diameter. During this process the matrix maintains its characteristics and properties. However, in the following step, after the drawing procedure, which drawing procedure is shown as an option, the conversion step is provided, for example, by a chemical processing step, in order to transform the metal matrix into an insulating matrix.

In another example, a two-step conversion or more-step conversion or multi-step conversion is provided. In the two-step conversion, the metal matrix is not converted by a single step into the insulator, but by a two-step reaction. For example, a suitable reaction is provided to form an intermediate hydride that is then finally converted to the oxide using oxygen or water. As an advantage, cracks may be formed in the matrix and a faster effusion is provided, such that the formation of the insulator is accelerated. A suitable material is, for example, titanium.

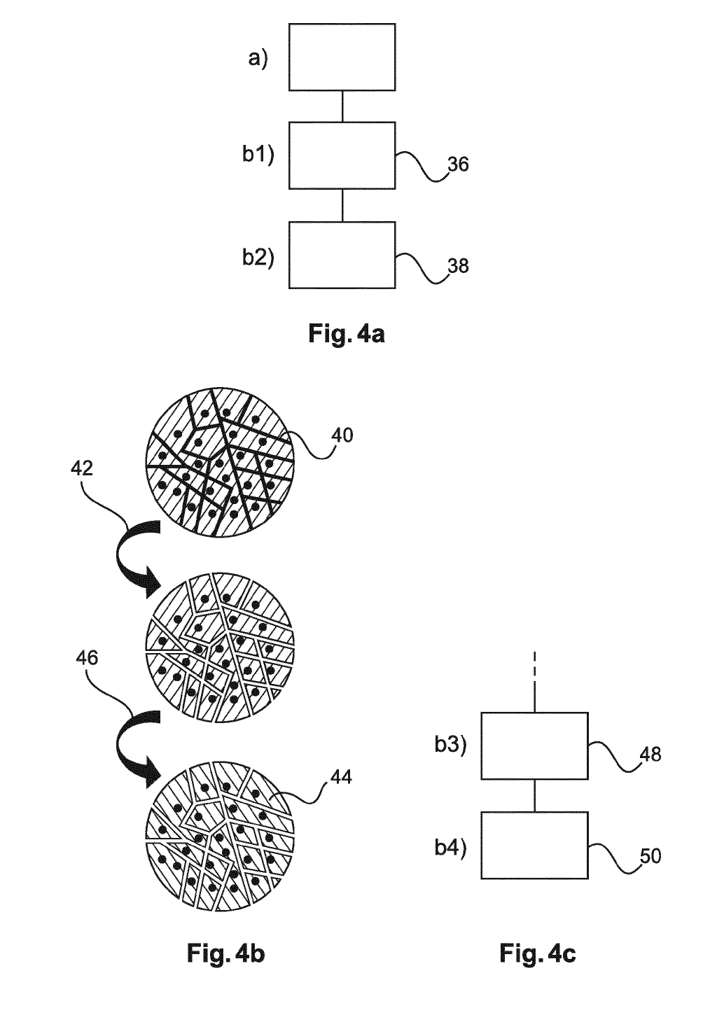

FIG. 4A shows an example wherein the matrix comprises a matrix material and at least a first material. In step b), it is provided the following sub-steps:

b1) a first sub-step 36 of converting a first material to form a plurality of cavities in the matrix; and
b2) a second sub-step 38 of using the formed cavities for activation of the second conversion sub-step, in which the matrix material is converted into insulation.

The second conversion sub-step may be provided as a chemical process. In an example, channels of dissolvable material are inserted beforehand. The channels may be provided with at least one connection to an outer surface of the strand.

FIG. 4B shows procedural steps of such a multi-step conversion. For example, so-to-speak as the starting state, channels 40 of the dissolvable material are inserted. The channels may have at least one connection to the wire surfaces. The copper conductors or other conductive wires are surrounded by a convertible material, in one example. First, the dissolvable material is removed, as indicated by a first arrow 42, representing a dissolution step. Next, the convertible material is reacting forming an insulator 44, which is indicated by a second arrow 46, indicating a conversion step. As an example, nickel is provided as the dissolvable material and aluminium as the convertible material.

Hence, FIG. 4B shows a two-step procedure. In a first procedure, the matrix is provided with a plurality of small openings in order to increase the surface for the conversion step. For example, by dissolving a material provided for this particular purpose in the matrix, ideally as channels or cracks around each conductive wire, but not necessarily, this material is then so-to-speak removed in the dissolution step, leaving openings in form of the matrix channels. Thus, as a result of the first step, a matrix material is provided having an increased surface compared to a simple cylinder, where only the circumferential surface is exposed in order to provide the conversion step as the second step. FIG. 4B shows that the increased surface area by the cracks, channels or the like provides an improved conversion step as the second step. As a result, a matrix having insulation properties is provided, thus enclosing the respective conductive wires.

FIG. 4C shows an example, wherein the first material is a dissolvable material, and wherein in step b) it is provided that:

b3) in a first sub-step 48, the first material is dissolved, thus forming the plurality of cavities; and
b4) in a second sub-step 50, the matrix material is converted into insulation of the conductive wires.

As indicated above, a sub-step of matrix dissolution may be provided. In such a step, the metal matrix may be dissolved completely. As before, this process leaves the copper unharmed, as an example. A number of liquid and gas phase reactions are provided, such as acid, alkali, complexing agent, liquid metals, electric chemicals, gas phase halogen etc.

As an example, a reaction is provided forming a nickel tetracarbonyl (Mond process), as it needs only very mild condition, for example, below 80° C., and as it is a clean gas phase reaction.

The copper conductors may touch each other, which leads to the provision of an additional strategy to provide the insulation.

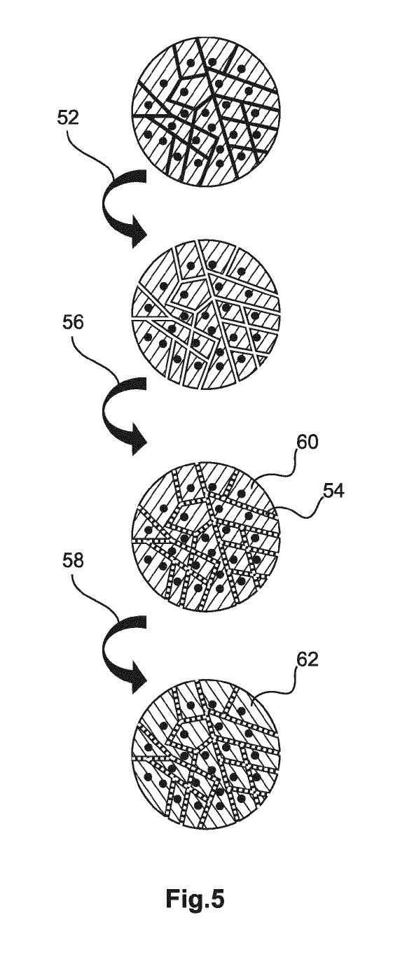

FIG. 5 shows a further procedure, according to which a dissolution step 52 is provided, in which the channel-like structures are dissolved. Next, the channels are used to be filled with a further material 54 in an impregnation step 56. In a conversion step 58 the resulting matrix structure 60 is converted into insulation material 62. The impregnation step 56 may also be referred to as sub-step b5) of providing a filling 59 of the cavities with second material.

In an example, after the dissolution step, the wire is impregnated with a polymer. A suitable surface tension with a high enough permeability is provided, such that a fill of polymer materials covers all the inner surfaces. For the conversion step, a high enough permeability to reaction counterparts is provided. For water, permeability may be provided high enough, however, for other gases pressurization and elevated temperatures may be necessary.

The stabilization effect of the polymer, according to the impregnation step, may allow for lower strength, but may provide it easier to react matrix metals, such as magnesium or iron.

In an example, the second material provides electric insulation. In a further example, the second material is a polymer providing additional structural strength. In a still further example, the second material provides additional electrical insulation.

In an example, after conversion step b), it is provided an additional step c) of providing an impregnation with a polymer.

Hence, FIG. 5 shows a three-step procedure. As mentioned in relation with FIG. 4B, in a first step, channels, cracks or other openings are provided by dissolving the material provided in the matrix material in order to increase the exposable surface. The material to be dissolved is provided in the matrix at the beginning, enclosing the conductive wires. After forming the channels, in a second step, these channels, cracks or the like are then filled with another material, in this case an impregnation material. This material provides further insulation, for example, or also stability or structural strength. The impregnation material can also be used for facilitating the conversion step as the third step. As a result, a matrix material is provided with insulating properties and with inserted net-like channels, providing additional functions.

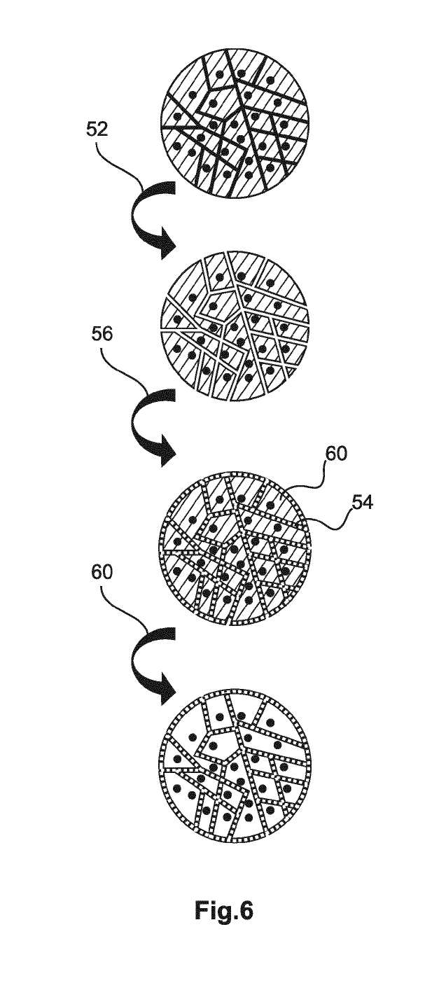

FIG. 6 shows an example, which is similar to the example of FIG. 5, but where the conversion step 58 is replaced by a dissolution step 60. For example, a suitable system would be aluminium as the material for the first dissolution (alkali) and nickel for the second dissolution step.

The second dissolution step may be formed in the final litz wire.

The filling centre of the litz wire can be adjusted simply by a pressing step. The advantage of this example is that it is relatively easy to make contact to this wire. The method would be a high force elevated temperature crimping that displaces the inside insulation polymer and makes direct contact to the copper.

Hence, FIG. 6 shows a three-step procedure. As described in relation with FIG. 4B and FIG. 5, as a first step, channels or the like are provided by dissolving a material provided for this purpose in the matrix material. As a result, a matrix with a number of channels or other openings is provided for providing an increased reaction surface of the matrix material, but also for providing a channel structure in form of a net- and a cross section, that can then be filled with impregnation material as the second step. The result is similar as described in relation with FIG. 5, mainly a matrix material, so far still being electrically conductive, with an integrated arrangement of a number of channels filled with a second material. However, in the third step, the matrix material is dissolved completely, leaving a frame-like structure of the impregnation grid, enclosing and thus stabilizing and insulating the conductive wires.

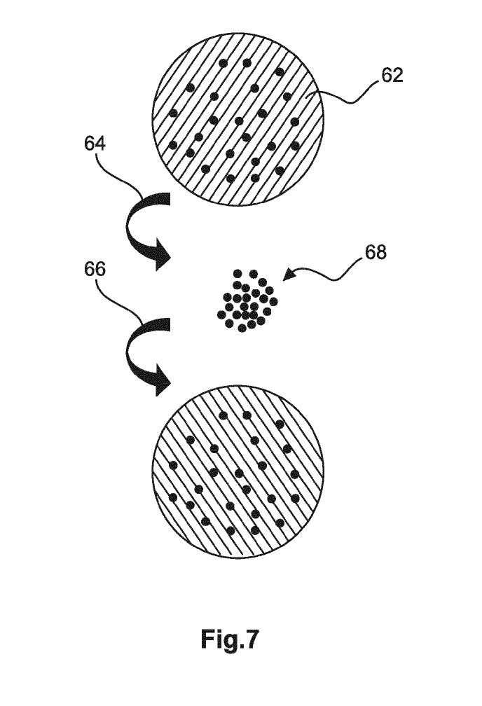

FIG. 7 shows a further example where a dissolvable material 62 is provided as matrix material. In a dissolution step 64, the matrix is dissolved completely. In a further provision step 66, a polymerization for separating the wires is provided, wherein for the polymerization, monomers polymerize by a catalytic surface of the conducted wires.

As indicated in an intermediate result 68, after having completely dissolved the matrix, the conductors may stick together. To separate the conductors, a polymerization step is employed where the liquid or gaseous monomers polymerize by the catalytic surface of the copper wires. To form the catalytic surface there may be a thin layer of a suitable metal on the copper surface, and there may be an activation step for the catalyst (e.g. by a chemical reaction).

The monomers, and in an example activators, need to diffuse through the formed polymer to reach the reaction site. During the reaction, the formed polymer needs to be solid by at least a very high viscosity material to push the other conductors away.

In an example, the polymerization of ethane catalysed by a thin layer of titanium (Ti) is provided that is activated with chlorine (Cl) to form TiCl₄, which acts as a Ziegerl-Natta-catalyst.

According to an example, not further shown, a plurality of channels is provided for the dissolution step b), and the matrix material remains as a block that holds the plurality of wires.

Hence, FIG. 7 shows another example of a two-step procedure. Contrary to other examples described above, in the first step, the matrix material is dissolved completely, leaving a bundle of conductive wires. This bundle is then so-to-speak unsupported and thus needs further treatment for providing a litz wire with capabilities of facilitated handling and the like. Therefore, after dissolving the matrix material, which provides the electric conductivity as the basic material, the conductive wires are then provided with an insulating and also stabilizing matrix, thus also prevents the conductive wires from sticking together. As an example, this is provided by catalytic growth as the second step.

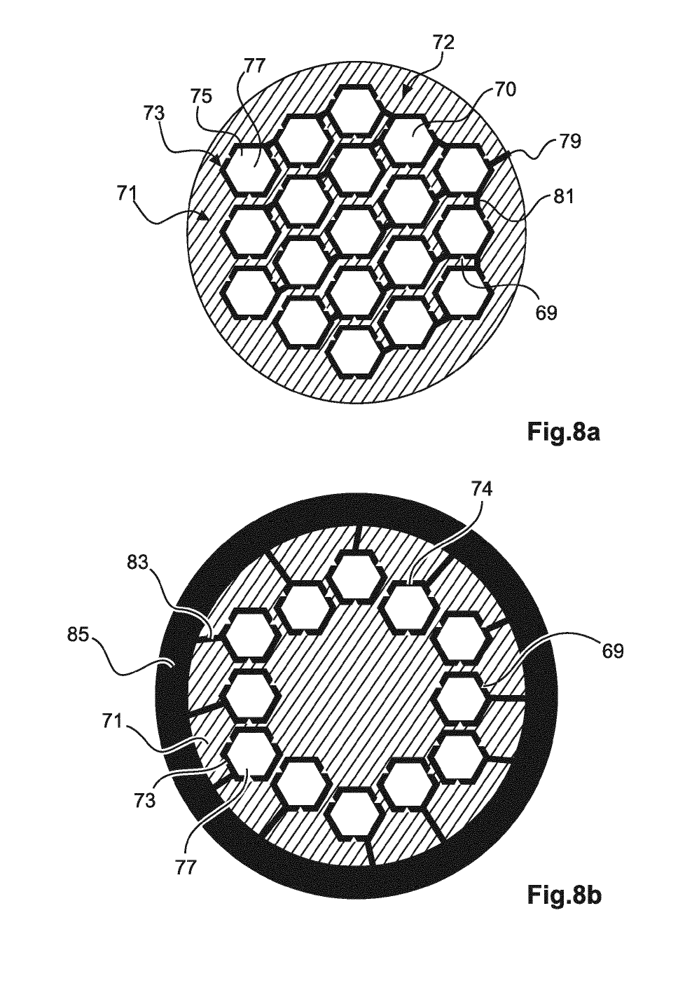

FIG. 8A shows an example, where the copper wires are provided with hexagonal cross-section 70, and the copper wires are arranged in a hexagonal structure 72. For example, the copper wires are arranged in an hexagonal structure pattern. With reference to FIG. 8A, it is noted that to avoid blocking of the etching channels that are also later used for filling, a repetitive bending in different directions during etching and filling may be provided.

Hence, the matrix material 71 provides a structural support with a plurality of enclosed channels or openings. In this example, the openings are provided as hexagonal forms 73. However, also other forms of a channel or opening in the cross section may be provided. Within the openings 73 in the matrix material 71 a lining or an in-between layer 75 is provided, enclosing the respective conductive wires 77. This space between the conductive wires 77 and the matrix material 71 is filled with a material, for which an insertion channel 79 is provided, and also connecting parts 81. Thus, the matrix 71 provides the structural support for arranging the conductive wires with their enclosing envelopes.

In an example, for providing the embedding coating, an intermediate space is provided between the conductive wires and a surrounding inner wall surface of the matrix structure. Spacers are provided in a circumferentially distributed manner for ensuring a minimum distance to be filled with the insulation material.

FIG. 8A further shows, as an option, the provision of a supporting structure for the conductive wires in form of small triangles 69. The triangles 69 can also have differing forms. This support structure ensures a holding of the wires in a defined minimum distance to the surrounding wall structures of the bores in the matrix. This space-holding function ensures that an insulation layer is provided at least on most of the conductor's (i.e. the wire's) outer surface. The part without insulation caused by the abutting triangles is relatively small. Due to the small fraction of the individual conductors being not insulated, a connection between the conductors is prevented. The triangles are provided as spacers.

FIG. 8B shows an example, where the copper wires are arranged as an outer line of a hexagonal-shaped form of a hexagonal structure pattern.

According to an example, in the strand, embedded in the matrix, the conductive wires are enclosed by an embedding coating 74, which is arranged around each conductive wire. In step b) there is provided:

b9) a first sub-step 76 of dissolving the embedding coating (not shown in FIG. 8B);
b10) a second sub-step 78 of the provision of an insulation of the conductive wires (also not shown); and
b11) a third sub-step 80 of dissolving the matrix.

According to a further example, not further shown, it is provided that a step of twisting or weaving or a plurality of thin conductive wires is provided either before step b), during step b) or after step b).

Hence, the matrix material 71 provides a structural support for providing the channels 73, also exemplarily shown as hexagonal cross sections. However, also other cross section forms, such as round or other forms may be provided. An intermediate space or gap is provided between the conductive wires 77 and the walls providing the channel 73. This gap is filled with a material, for which also connecting ducts 83 are provided connecting the gap-space around the conductive wires with a circumferential space 85.

An arrangement similar to FIG. 8b, and a slightly different method of manufacturing, may also be provided (not depicted), starting from a material element, e.g. of a cylindrical shape e.g. of 150 mm diameter and 200 mm length, made of e.g. low carbon iron, which is electrical discharge machined to provide the shaped matrix material 71 including the spikes 69. Alternatively to the hexagonal channels 73 of FIG. 8b, the channels of this arrangement may be round with the same type of connections 83 to the outside as the ones depicted in FIG. 8b. The diameter of these channels may be about 20 mm for the above-mentioned exemplary dimensions of the cylindrical matrix 71. Aluminum connecting ducts 74 and coatings 83, having a determined thickness (of e.g. about 2 mm) are machined to fit onto the walls of the channels 73 and into the connecting channels (83). The remaining inner channels are filled with copper materials to form copper rods (i.e. with a diameter of about 16 mm). The whole assembly is placed inside a tube 85, e.g. 150 mm inside diameter (of e.g. aluminum) with a wall thickness of about 4 mm. The assembly is rolled and drawn, e.g. to a final diameter of about 160 μm. Then drawn assembly is conversed by etching (e.g. in a chamber according to FIG. 10) using e.g. warm sodium hydroxide solution for converting aluminum. Afterwards the assembly may be rinsed, e.g. several times (e.g. in water), and may finally be dried. The assembly may be thereafter impregnated (e.g. in a chamber described in FIG. 11) using a material having good high-frequency characteristics (i.e. low loss tangent, low permittivity, and high dielectric strength—e.g. relative permittivity lower than 4 (e.g. 3 or lower), a loss tangent lower than 1 e-3 and a dielectric strength greater than 10 kV/mm (preferably several tenth of 10 kV, preferably greater than 100, preferably about or greater than 200 keV)) e.g. a molten polypropylene material for best possible high frequency characteristics. The outer surface of the assembly is preferably free of residual polymer after the impregnation step: indeed it may be preferable to impregnate the channels 74 and 83 (now free of Aluminum) around the conductive wires 77 and leave the outside (iron) surface 85 non-impregnated (e.g. by said polymer), as it would prevent the chemical removal of the iron thereafter. So some sort of cleaning step may be needed after impregnation, if the tolerances in the holes of the impregnation machine in FIG. 11 are too loose (If the holes tightly fit, no residual polymer remains on the surface 85). Such a cleaning may be done with suitable knives or brushes where the wire is drawn along.

After having implemented this method of manufacturing, the final assembly constitutes a Litz wire made of a plurality of conductive wires 77 (e.g. twelve as depicted in FIG. 8b). This Litz wire may be thereafter twisted with other similar Litz wires to form a first “generation” of stranded Litz cable. If a Litz cable with more conductive wires 77 is desired, the first generation Litz cable may be twisted again with other similar first generation Litz cables into a second generation Litz cables. And so on if there is a need of more conductive wires 77. So, in an example of a Litz wire having twelve conductive wires 77 (as depicted in FIG. 8b), which is firstly twisted with four other similar Litz wires to form a first generation Litz cable, which first generation Litz cable is twisted with four other similar first generation strand, a second generation Litz cable formed of three hundred (12*5*5) twisted conductive wires 77 (e.g. having each 16 μm diameter) is finally obtain.

The assembled Litz wire or Litz cable is thereafter immersed in an acid or corrosive solution to remove the matrix material, e.g. 30% hydrochloric acid to remove the iron. This last step is an important one as it is highly preferable that all the non-copper metallic material is removed in the end to have a working Litz wire. Preferably, this operation is done in an environment having a very low or no oxygen concentration in order to avoid the etching of the coper if any uncovered copper area is present. Once all iron is removed, the Litz wire or Litz cable may be washed several times e.g. in distilled water, until no acid can be traced any more. After a drying step, silk may be spun around the Litz wire or Litz cable.

In another exemplary arrangement, quite similar to the preceding example, a shaped matrix material 71, e.g. a cylinder of 150 mm diameter and 200 mm length, e.g. of aluminum, is provided. A determined number of holes (e.g. 21), with e.g. a diameter of 20 mm, are drilled through the faces of the matrix material 71 in a determined arrangement, e.g. regular arrangement around the axis of the cylinder. Closely fitting tubes, e.g. of titanium, with e.g. a wall thickness of 2 mm, are inserted and/or deposited. In the remaining holes metallic material, e.g. of copper, are inserted and/or deposited to form rods. The whole assembly is rolled and drawn, to e.g. a final diameter of about 150 μm. The assembly is formed to a Litz wire or Litz cable as in the preceding arrangement. The whole Litz wire is treated for matrix dissolving purpose, e.g. with sodium hydroxide solution to dissolve the aluminum matrix. Then a silk coating is provided by spinning around the Litz wire to give the Litz wire some mechanical strength as it is commonly well-known in Litz wire manufacturing. The conversion step may be done electrochemically to form titanium oxide as described in J. Aust. Ceram. Soc. 43 [2] (2007) 125-130. The conversion step may be done only over the length needed for a single product (e.g. one coil) each time, such that the parts of the conductive wires 77 to be connected to the current source (e.g. terminal parts of the conductive wires 77) are not converted such that they can stay purely metallic (not oxidized) to allow a better connection. In an alternative case of a polymer coating or impregnation (e.g. see the above-mentioned previous exemplary arrangement), this preservation of the connection part of the conductive wires 77 can be performed by e.g. a hot crimping process: in this process the polymer is softened (melted) and sufficiently large pressure pushes the insulator out of the crimping region. For oxide insulators (like the titanium oixide of this exemplary arrangement), this is not as easily possible and the best way to provide a good contact is to avoid the formation of the oxide at the positions where contacts are desired.

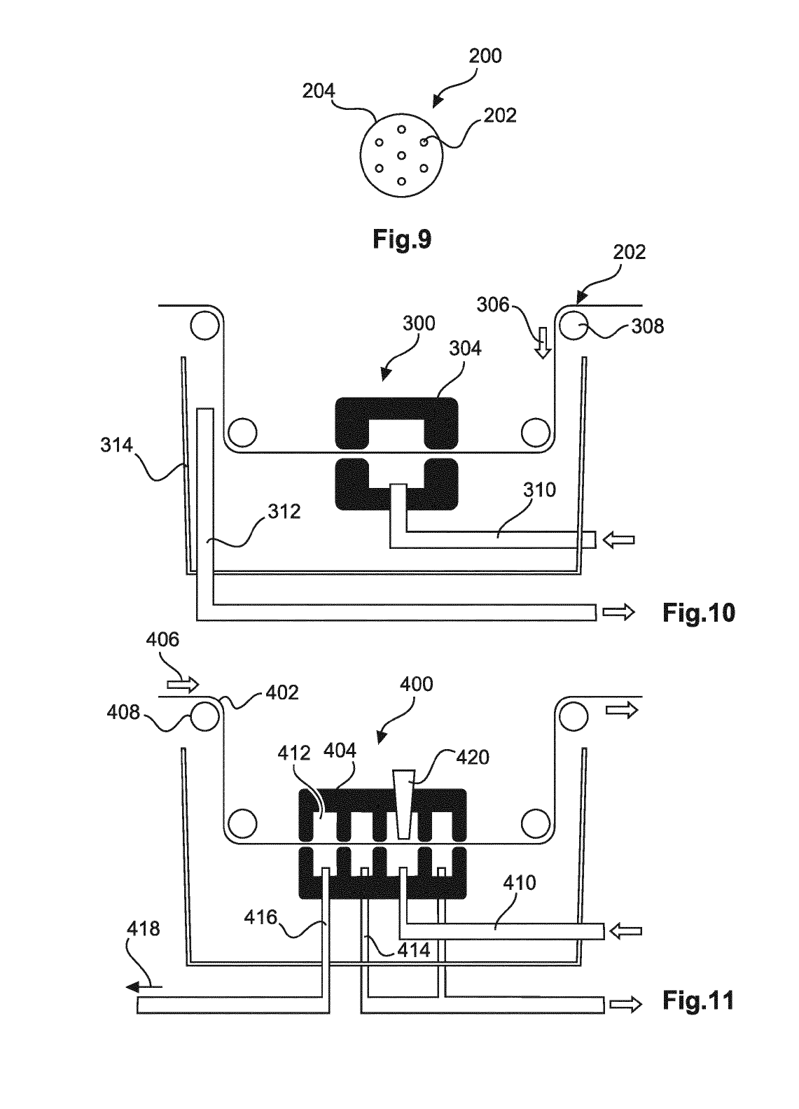

FIG. 9 shows an example of the litz wire 200 in a cross section in a very simplified illustration. The litz wire 200 comprises a plurality of thin conductive wires 202 that are electrically insulated from each other. The plurality of thin conductive wires 202 and the insulation 204 is manufactured by a method according to the examples described above.

In an example, platinum in silver wires are manufactured with a diameter of approximately 8 μm (micrometer), thus, further allowing a reduction of diameters in a drawing process. Nevertheless, the effusion or alloying of different metals may provide a limit for some metal combinations. However, at least in the processes where the stranding can be performed after the main metal dissolution, there seems to be no limit for the size of conductors and the quantity in the first generation in the strands. The number of conductors in the first generation may be provided so low that the skin effect does not result in significant variations in the currents through the conductors. In a practicable reachable filling factor, a small conductor diameter is decreased and high design frequencies are provided. The filling factor may be decreased with smaller conductors as the relative size of the insulating layer increases. For example, filling factors of up to 50% can be expected down to 5 μm-conductors in one example. Therefore, according the present invention, the thus provided litz wire is used for magnetic particle imaging, magnetic resonance imaging, inductors and transformers, antennas and filters, high frequency cables, or telecommunication cables.

In FIG. 10, an etching chamber 300 as an example for a conversion chamber is shown for the conversion step. A strand 302 with a plurality of thin wires made of conductive material embedded in a matrix is provided. The matrix has first characteristics comprising metallic connection of the conductive wires and the matrix, and comprising electrical conductivity for electrical connecting of the conductive wires and the matrix. However, this composition or these parameters of the strand are only provided before the strand enters the high pressure compartment 304. A direction arrow 306 indicates a travelling direction of the strand 302, shown by respective rolls and driving arrangements, of which only rolls 308 are schematically indicated. An etching liquid is provided by liquid feed 310. The etching liquid is provided, for example, with a 100 bar pressure. Inside the pressure compartment 304 the strand is exposed to the etching liquid. After the treatment with the etching liquid, which provides a conversion step of the matrix material, the strand 302 leads to the high pressure etching chamber, but now having different characteristics, namely the matrix material is converted into material having second characteristics comprising electrical insulation for providing the plurality of thin conductive wires with an electrical insulation. A feedback line 312 provides a discharge of the etching liquid from a basin-like structure 314.

It is noted that the etching chamber 300 may be provided for one of the above mentioned conversion (sub-) steps, where a matrix material is converted into material with insulating properties.

FIG. 11 shows a further example of an impregnation chamber 400, for one of the sub-steps of the conversion. A strand 402 is provided having a plurality of thin wires made of conductive material embedded in the matrix, which matrix is having first characteristics comprising metallic connection of the conductive wires and the matrix, and comprising electrical conductivity for electrically connecting of the conductive wires and the matrix. In an example, the impregnation is provided after one conversion step, such as an etching step. The strand 402 is fed to a high pressure chamber 404. Moving arrows 406 indicate that travelling direction of the strand. The above mentioned first properties are only provided for the strand before the strand enters the impregnation chamber 400. After leaving the chamber, at least a part of the matrix material is converted to a material having second characteristics, comprising electrical insulation for providing the plurality of thin conductive wires with an electrical insulation. Rolls 408 symbolically indicate the respective equipment for travelling of the strand 402. A varnish is provided by a varnish feed line 410 inside the impregnation chamber 304, comprising several sub-compartments 412. A discharge arrangement 414 provides the discharge of the varnish after used for the conversion sub-step. Still further, a vacuum line 416 is provided for applying a vacuum by a vacuum pump, not further shown, but indicated with a vacuum arrow 418. Still further, an ultrasound emitter 420 is provided for supporting the conversion step inside the impregnation chamber.

It is noted that the impregnation chamber 400 may be provided for one of the above mentioned impregnation (sub-) steps, where a second material is inserted into the channels provided in the matrix.

After having implemented the method of manufacturing, the final assembly constitutes a Litz wire made of a plurality of conductive wires 77 or 22 (e.g. twelve as depicted in FIG. 8b). This Litz wire may be thereafter twisted with other similar Litz wires to form a first “generation” of stranded Litz cable. If a Litz cable with more conductive wires 22 or 77 is desired, the first generation Litz cable may be twisted again with other similar first generation Litz cables into a second generation Litz cables. And so on if there is a need of more conductive wires 22, 77. So, in an example of a Litz wire having twelve conductive wires 22, 77 (as depicted in FIG. 8b), which is firstly twisted with four other similar Litz wires to form a first generation Litz cable, which first generation Litz cable is twisted with four other similar first generation strand, a second generation Litz cable formed of three hundred (12*5*5) twisted conductive wires 22, 77 in the case of twelve conductive wires 22, 77 is finally obtain.

As an alternative the first generation may be implemented during the manufacturing, e.g. before the oxidization of the matrix material 71, and the final steps of the method is performed on the whole Litz cable.

It is to be noted that, such a Litz wire or Litz cable, manufactured by using the method of manufacturing according to the invention comprises the following specific features:

In case of polymer filling or impregnation:

Nose (filling channel) on the insulator material of the Litz wire.

Noses on the conductive wire 22, 77 and no (or little) polymer on top of them.

Meandering of material of the conductive wires 22, 77 core in the polymer shell (if no noses are present)

Residual impurities in the polymer (in particular, quite a good evidence if the concentration decreases from outside to inside)

In case the matrix material 71 has been oxidized:

multiple conductive wires 73 in metal oxide.

third metal impurity in oxide material gives some level of evidence, if there are single oxide covered strands (in particular, quite a good evidence if the concentration decreases from outside to inside).

Non-oxidized connecting portions of the conductive wires 77 (which is only practical, if oxidation step is done after the Litz manufacturing process).

In all cases:

characteristic deformation on shape of the conductive wires 77 due to the different hardness of the different materials

other metal impurities (e.g. aluminum in copper) by diffusion in the drawing process.

Non uniform concentration of impurities (in particular, quite a good evidence if the concentration decreases from outside to inside).

Very thin (5 μm or below) conductors.

Other ways to identify the Litz wire according to the manufacturing process of the invention may be identified.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features. While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A system for manufacturing litz wire, the system comprising:
a provision unit; and
a conversion unit;
wherein the provision unit is arranged to provide a strand with a plurality of thin conductive wires embedded in a matrix,
wherein the matrix has a first characteristic, the first characteristic comprising:
a metallic connection of the thin conductive wires and the matrix; and
an electrical conductivity, the electrically conductivity arranged to electrical connection of the thin conductive wires and the matrix;
wherein the conversion unit is configured to convert at least a portion of the matrix into material having a second characteristic, the second characteristic comprising electrical insulation, the electrical insulation providing at least a portion of the plurality of thin conductive wires with electrical insulation.

2. The system according to claim 1,
wherein the thin conductive wires are metal wires,
wherein, the wires are selected from the group of consisting of copper wires, copper alloy wires, aluminum wires and aluminum alloy wires.

3. A method for manufacturing litz wire, comprising
providing a strand with a plurality of thin wires made from conductive material,
wherein the conductive material is embedded in a matrix, the matrix having a first characteristic, the first characteristic comprising:
a metallic connection of the thin wires and the matrix; and
an electrical conductivity, the electrically conductivity arranged to electrical connection of the thin wires and the matrix;
converting of at least a portion of the matrix into material having second characteristics comprising electrical insulation for providing at least a portion of the plurality of thin wires with electrical insulation.

4. The method according to claim 3, further comprising drawing the strand for reducing a cross section of the embedded thin wires prior to the converting of at least a portion of the matrix.

5. The method according to claim 3,
wherein the converting of at least a portion of the matrix comprises chemically processing the matrix for the conversion into the electrical insulation; and
wherein in the chemically processing step, a gas is provided that reacts with the matrix to form an insulating material.

6. The method according to claim 3,
wherein the matrix comprises a matrix material and at least a first material,
wherein the converting of at least a portion of the matrix comprises:
converting and/or replacing the first material to form a plurality of cavities in the matrix; and
using the formed cavities for activation of a second conversion, wherein the second conversion converts the matrix material into insulation.

7. The method according to claim 6,
wherein the first material is a dissolvable material,
wherein the converting of at least a portion of the matrix comprises:
forming the plurality of cavities by dissolving the first material; and
converting the matrix material into insulation of the thin wires.

8. The method according to claim 6 further comprising:
filling the cavities with a second material; and
dissolving the matrix material after filling the cavities with the second material.

9. The method according claim 3 wherein the converting of at least a portion of the matrix comprises:
dissolving the matrix completely; and
providing a polymerization for separating the wires, wherein for the polymerization, monomers are polymerized by a catalytic surface of the conductive wire.

10. The method according to claim 8,
wherein a plurality of channels are provided prior to the converting of at least a portion of the matrix comprises
wherein the matrix material remains as a block that holds the plurality of wires.

11. The method according to claim 3, wherein the thin wires are enclosed by an embedding coating that is arranged around each thin wire further comprising:
dissolving the embedding coating;
providing an insulation of the thin wires; and
dissolving the matrix.

12. The method according to claim 11,
wherein an intermediate space is provided between the thin wires and a surrounding inner wall surface of the matrix structure
wherein spacers are provided in a circumferentially distributed manner,
wherein the spacers are arranged to ensure a minimum distance to be filled with insulation material.

13. A litz wire (200), comprising a plurality of thin conductive wires that are electrically insulated from each other and embedded in a matrix, wherein at least a portion of the matrix has been converted from a conductive material and/or replaced by an electrically insulated material.

14. The litz wire as claimed in claim 13,
wherein the electrically insulated material comprises a minimum amount of ionic insulator of approximately at least 10% per weight of the conductor; and
wherein each of the thin conductive wires has a maximum individual conductor diameter of approximately at 80 μm.

15. The litz wire as claimed in claim 13, comprising non-uniform concentration of some impurities, wherein a material of these impurities is different from the conductive material of the thin conductive wires and the insulator material in the matrix,
whose concentration may decrease from the outer surface to the inner portion of the Litz wire.

16. The litz wire as claimed in claim 13, wherein the matrix is mostly made of metal oxide.

17. The litz wire as claimed in claim 13, comprising nose or filling channel on the insulator material of the matrix or on the conductive wires.

18. The litz wire as claimed in claim 13, comprising nose or filling channel on conductive wires and no or little polymer on top of them.

19. A system for manufacturing litz wire, the system comprising:
a provision unit; and
a conversion unit;
wherein the provision unit is arranged to provide a strand with a plurality of thin conductive wires embedded in a matrix,
wherein the matrix has a first characteristic, the first characteristic comprising:
a metallic connection of the thin conductive wires and the matrix; and
an electrical conductivity, the electrically conductivity arranged to electrical connection of the thin conductive wires and the matrix;
wherein the conversion unit is configured to replace at least a portion of the matrix into material having a second characteristic, the second characteristic comprising electrical insulation, the electrical insulation providing at least a portion of the plurality of thin conductive wires with electrical insulation.
